(19) United States
(12) Patent Application Publication
(10) Pub. No.: US 2005/0250002 A1
(43) Pub. Date: Nov. 10, 2005

(54) Composite catalyst layer, electrode and passive mixing flow field for compressionless fuel cells

(75) Inventors: Kevin G. Stanley, Vancouver (CA); Yanghua Tang, Vancouver (CA); Eva Czyzewska, Vancouver (CA); Jodie Capling, Montreal (CA); Q.M. Jonathan Wu, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: National Research Council of Canada, Ottawa (CA)

(21) Appl. No.: 11/116,214

(22) Filed: Apr. 28, 2005

Related U.S. Application Data
(60) Provisional application No. 60/565,834, filed on Apr. 28, 2004.

(51) Int. Cl. H01M 4/86; H01M 8/10; H01M 4/96; H01M 4/90; H01M 4/88

(52) U.S. Cl. 429/44; 429/30; 429/42; 429/38; 502/101

(57) ABSTRACT

The application relates to improvements to the composition and architecture of compressionless fuel cells. The invention includes a hybrid or composite catalyst layer which includes a blend of catalyst particles, such as platinum on carbon, and fibers, such as graphite fibers. The invention also relates to a castable gas diffusion layer (GDL) which is both porous and electrically conductive. The GDL is formed from conductive metal flakes, such as gold and silver, carbon particles and binder to hold the flakes and particles together to form a porous foam microstructure. The invention further relates to a modified flow field for flowing fluid to or from the catalyst layer of a fuel cell. The flow field comprises at least one primary channel having a longitudinal axis and a plurality of secondary channels extending transversely from the primary channel at an angle relative to the longitudinal axis. The secondary channels induce the fluid flow path to rotate to thereby passively increase the probability of contact and mixing between the fluid and the catalyst layer. This in turn improves the delivery of reactants to the catalyst layer and the removal of reaction products from the catalyst layer. The catalyst layer, GDL and flow field may be synergistically combined to improve the efficiency and performance of compressionless micro fuel cells.

### REFERENCE TO RELATED APPLICATION

This application claims the benefit of U.S. provisional patent application No. 60/565,834 filed Apr. 28, 2004 which is hereby incorporated by reference.

### TECHNICAL FIELD

This application relates to improvements to compress ionless fuel cells.

### BACKGROUND

In most fuel cells, compression is used for sealing and to reduce the electrical contact resistance of the various layers of the fuel cell stack. For even moderately sized stacks, space consumed by the compression plates and bolts is modest compared to the space occupied by the bipolar and cooling plates. However, for micro fuel cells space is at a premium and the volume required for compression can be several times the volume of the entire system. While novel, space-saving compression architectures are possible, to truly minimize the cell volume compression requirements must be limited or preferentially eliminated.

Sealing can be accomplished using adhesives, or various bonding techniques in place of compression seals. This not only reduces the requirements of compression, but also reduces the fuel cell footprint by removing bulky compression seals outside the active area. Similarly, the contact resistance between layers of the stack, such as the electrode and current collector, can be diminished by depositing the current collector in close proximity to the electrode. The inventors have previously demonstrated adhesive based sealing and deposition-based contact in pending U.S. patent application Ser. No. 10/454484 (Publication No. US-2004-0053100-A1) which is hereby incorporated by reference.

These techniques cannot, however, reduce the contact resistance within a catalyst layer. A catalyst layer is essentially a compacted powder. By compacting the powder, the contact resistances become negligible, and the layer acts as if it is conductive. In an uncompressed state, the powder has a conductivity on the order of 50 S/cm. This electrical resistance dominates the behavior of the cell. To completely solve the compression problem, a method of increasing the conductivity of the catalyst layer without significantly impacting the pore structure and catalyst loading of the cell is required.

Micro fuel cell designs are often required to work at very low flow rates to minimize the parasitic losses from pumping. However, slow moving liquids form depletion and saturation layers near the catalyst, as fuel is consumed and replaced with products in a direct methanol fuel cell (DMFC) anode and oxygen is consumed and replaced with water at a fuel cell cathode.

The need has therefore arisen for improvements to the composition and architecture of compressionless fuel cells.

### SUMMARY OF INVENTION

In a first embodiment, the present invention a hybrid catalyst layer deposited on a membrane substrate. The hybrid catalyst layer comprises a plurality of catalyst particles and a plurality of fibers blended with the catalyst particles, wherein the concentration of the catalyst particles decreases with increasing distance from the membrane. In one embodiment the fibers are not in contact with the membrane and the concentration of the fibers increases with increasing distance from the membrane. For example, the concentration of the catalyst particles may decrease gradually in proportion to distance from the membrane and the concentration of the fibers may gradually increase in proportion to distance from the membrane.

The catalyst layer is preferably uncompressed and electrically conductive. The layer may for example comprise a Nafion® ionomer.

In one embodiment the catalyst particles comprise platinum on activated carbon and the loading of platinum on the activated carbon increases as the concentration of the catalyst particles in the layer decreases. The fibers may comprise graphite fibers.

In one particular embodiment, the catalyst layer may comprise a plurality of sub-layers, wherein the weight percentage of the fibers in the sub-layers varies. For example, the weight percentage of the fibers increases with increasing distance from the membrane.

The invention also relates to an electrode subassembly for a micro fuel cell comprising a polymer electrolyte membrane and a hybrid catalyst layer as described above coated on the membrane. The invention further relates to a micro fuel cell comprising an electrode subassembly as described above and a current collector contacting the hybrid catalyst layer.

The invention also encompasses a method of forming a hybrid catalyst layer by providing a membrane substrate; depositing a primary sub-layer of catalyst particles on the membrane; and successively depositing a plurality of secondary sub-layers on the membrane overlying the primary sub-layer Each of the secondary layers comprises a blend of catalyst particles and fibers such that the concentration of fibers in the layer gradually increases with increasing distance from the membrane. In one embodiment each of the sub-layers is deposited as an ink and may include a conductive ionomer

In another embodiment the invention also relates to a porous, conductive gas diffusion layer for a fuel cell electrode. The conductive gas diffusion layer includes conductive metal flakes, carbon particles and binder holding the flakes and particles together to form a porous foam microstructure. The conductive metal flakes are preferably formed of silver or gold, the carbon particles are selected from the group consisting of carbon rods, carbon fibers and carbon powder, and the binder may be epoxy. The resulting gas diffusion layer may be castable.

The invention may relate to the combination of the hybrid catalyst layer as described above and a conductive gas diffusion layer as described above deposited thereon. The subassembly may be uncompressed in the case of compressionless fuel cells.

In a further embodiment the invention relates to a flow field for flowing fluid to or from the catalyst layer of a fuel cell. For example, the fluid delivers reactants to the catalyst layer and removes reaction products from the catalyst layer to increase the mixing efficiency of the fluid and the catalyst layer. The flow field comprises at least one primary channel having a longitudinal axis and a plurality of secondary channels extending transversely from the primary channel at an angle relative to the longitudinal axis. The fluid flows within the primary and secondary channels at least part of the time in a non-uniaxial flow path to passively increase the probability of contact between the fluid and the catalyst layer. Preferably the non-uniaxial flow path is a rotating flow path. The rotating flow may be caused by the development of a pressure gradient at interfaces between the primary channel and the secondary channels. The flow of fluid through the primary and secondary channels is preferably laminar.

In one embodiment the angle between a secondary channel and the primary channel is an oblique angle. The secondary channels may extend from a bottom or side surface of the primary channel. Preferably the secondary channels may be arranged at regular intervals along the longitudinal axis.

The invention encompasses the combination of an electrode subassembly comprising a catalyst layer as described above and a flow field as described above. The combination may further include a gas diffusion layer as described above in electrical contact with the catalyst layer.

### BRIEF DESCRIPTION OF DRAWINGS

In drawings which describe embodiments of the invention but which should not be construed as restricting the spirit or scope thereof,

FIG. 1 is a cross-sectional view of a hybrid particle-fiber catalyst layer.

FIG. 2 is a graph showing resistance of different catalyst layers having varying degrees of carbon fiber loading.

FIG. 3(a) is a scanning electron microscopy (SEM) image of a hybrid catalyst layer on Nafion® 117 substrate.

FIG. 3(b) is a cross-sectional SEM view of the catalyst layer and substrate of FIG. 3(a).

FIG. 4(a) is a scanning electron microscopy (SEM) image of a hybrid catalyst layer on a supported membrane

FIG. 4(b) is a cross-sectional SEM view of the catalyst layer and substrate of FIG. 4(a).

FIG. 5 is a schematic diagram of a microcell electrode comprising a hybrid catalyst and a current collector.

FIGS. 6(a)-6(d) are SEM images of various compositions of porous castable electrodes.

FIG. 7 is a schematic diagram of a flow field and catalyst layer having a primary channel and a series of secondary channels or grooves extending transversely from the primary channel.

FIG. 8 is a graph showing fluid rotation (angle index) and mixing efficiency versus channel width.

FIG. 9(a) shows the results of computational fluid dynamics (CFD) computer simulations of flow patterns in a flow field architecture having secondary channels or grooves.

FIG. 9(b) shows the results of CFD computer simulations of flow patterns in a flow field having no transverse secondary channels or grooves.

FIG. 10(a) is a graph showing fluid rotation (angle index) and mixing efficiency versus channel width.

FIG. 10(b) is a graph showing the velocity pattern in a flow field channel.

FIG. 11(a) is cross-sectional view of a flow field channel having ridges partially obstructing fluid flow.

FIG. 11(b) is cross-sectional view of a flow field channel having a plurality of transverse grooves or secondary channels formed in a surface of a primary channel.

FIG. 12 is a graph showing changes in oxygen concentration over the length of a channel (distance). The oxygen mass fraction was measured in the middle of an interface between the gas diffusion layer and flow channel near the cathode in a PEM fuel cell.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Electrodes/Catalyst

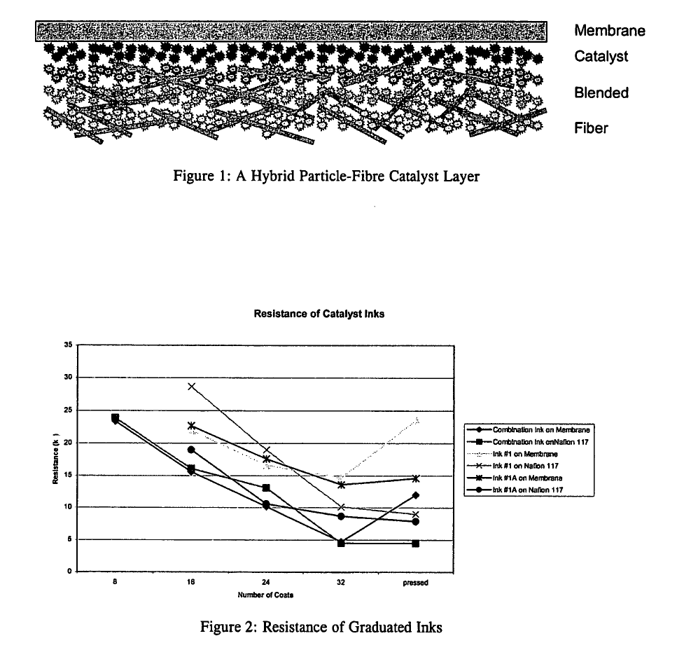

According to the invention, a novel hybrid or composite catalyst layer combining platinum on carbon catalyst particles blended with short graphite flakes, rods or fibers significantly improves the conductivity of the catalyst layer in an uncompressed configuration. In one embodiment where the amount of graphite rods or fibers in the catalyst layer increases with distance from the membrane in a graduated manner, the catalyst concentration near the membrane is maximized, while maintaining increased conductivity within the layer. To compensate for the loss of active area, the catalyst loading within the layer can be increased as the graphite loading is increased. For example, as shown in FIG. 1, 20% platinum on carbon catalyst particles could be used near the membrane while, 10 microns into the catalyst layer, the volume would be 50% occupied by graphite rods, and a 40% platinum on carbon loading would be used. As will be apparent to a person skilled in the art, other types of catalysts could be employed depending upon the application, such as platinum in combination with other elements like ruthenium, or non-platinum, non-precious metal catalysts.

In the embodiment illustrated in FIG. 1, the total electrode layer thickness is approximately 20 um. In the first 5 um, there are no graphite particles, and electrical conductivity occurs from particle-to-particle contact. In the adjacent blended region, catalyst particle volume decreases in proportion to the fiber volume, and platinum loading increases proportionately. In the subsequent adjacent fiber portion of the electrode, the volume is predominantly occupied by fibers, with few, highly loaded catalyst particles.

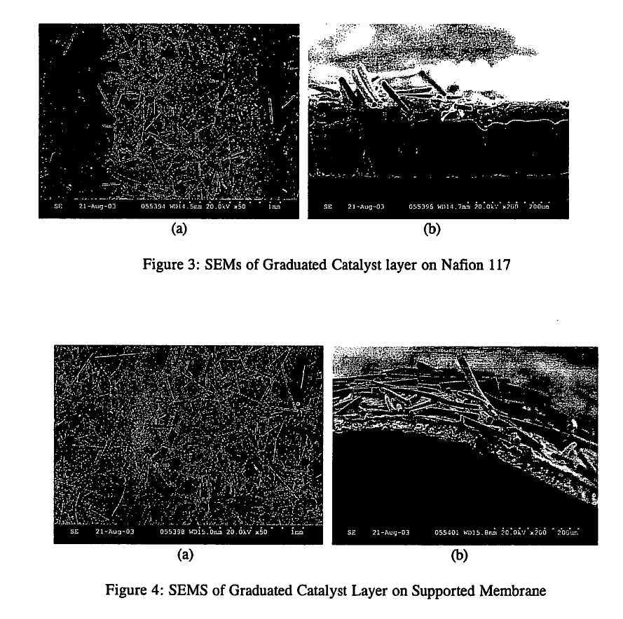

The hybrid structure shown in FIG. 1 can be achieved by depositing a series of catalyst inks by spraying, painting or squeegee operations, and can be patterned by printing or stenciling. By way of example, the inventors developed several fuel cell electrodes, and analyzed the impact of their structures on resistance and performance (FIGS. 2 and 3).

In particular, a series of inks with different weight percentages of fibers were used to create a catalyst layer that had a graduated carbon fiber loading. The distance from the membrane and the amount of carbon fiber are directly proportional. This combination ink was compared with a catalyst ink which contained no carbon fibers.

An ink #IA was also tested. This ink was similar to a test ink #1, however instead of carbon powder, it was made with platinum supported on carbon powder (20.3% Pt/C). All three inks were tested on both an in-house Nafion®-impregnated glass membrane and commercial Nafion® 117 (FIG. 2).

In each case a total of 32 coats of catalyst were applied. For the combination ink, the order that the inks were applied in, and the number of coats of each ink is listed below:
1. 8 coats of ink #1 (0% carbon fiber)
2. 8 coats of ink #9 (25% carbon fiber)
3. 8 coats of ink #6 (50% carbon fiber)
4. 8 coats of ink #7 (100% carbon fiber)

Each ink contained 30% Nafiong ionomer as a proton conductor and binder. The resistance was measured after each different type of ink was applied for the combination ink, and after 16, 24, and 32 coats for ink# 1 and ink #1A

The ink was applied to the Nafion® or the membrane in a pattern of 13 strips of 30 mm in length and approx. 1.20 mm in width. The total width of the pattern is 30 mm. The resistance of the length of each strip was measured and then the average was taken for each cell.

It is evident from FIG. 2 that the carbon fibers reduce the resistance of the catalyst layer significantly on the membranes and moderately on Nafion® 117. It is believed that the decrease in conductivity due to the surface roughness of the supported membrane was mitigated by the carbon fibers, resulting in a greater change in conductivity. There was a dramatic increase in the resistance after pressing. This is largely due to catalyst losses on the pressing plates. Altering the pressure and dwell time should mitigate this effect. In this example there was no perceptible difference in resistance between the catalyzed and uncatalyzed inks. Because the resistance effects are dominated by particle-to-particle contact resistances, the bulk conductivity does not affect the overall resistance. SEM images of the deposited inks are illustrated in FIGS. 3 and 4.

The form of the layers is quite clear in the SEM images. The cross-section of the Nafion® 117 membrane (FIG. 3(b)) is particularly interesting because it demonstrates the effect of the carbon fibers. Instead of percolating through the catalyst layer from particle to particle, the current can quickly travel through the carbon fiber links and out to the edge collected bulk current collectors.

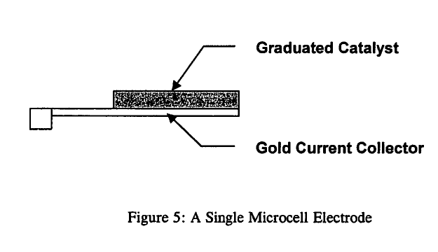

Fuel cells have been fabricated using the original micro cell fabrication technique with the graduated catalyst layer, which consists of several edge collected electrodes as shown in FIG. 5.

The resistance from the catalyst layer to the electrode varied significantly over the 3 cm length of the catalyst. The change in resistance was primarily attributed to the orientation of the carbon fibers. In areas where the carbon fibers were perpendicular to the gold current collector, the carbon rod provided a short circuit path, reducing the resistance to as little as 75 Ohms. In areas where the carbon rods were predominantly parallel to the gold current collector, there was no change in path, and the resistance was several kiloohms.

Preliminary tests of the performance of the microcell with the new hybrid catalyst layers described herein indicate more than 4 times the peak current density for a single cell, with the short circuit current increasing from 1 mA to 4 mA (3 mA/cm² to 12 mA/cm²).

Castable Gas Diffusion Layer

In another embodiment of the invention, a porous, highly conductive layer is deposited directly on the catalyst layer to eliminate the need for edge collection of the current along the membrane, increasing the available membrane area. The inventors have created such a high conductivity porous, castable layer from a mixture of silver or gold flakes, carbon rods, carbon powder and binder.

Resistance for these new electrodes varies from 3 Ω/cm to 200 Ω/cm, and porosity varies from micro to macro porous. Conductivity in the layers occurs from platelet-to-platelet contact between the silver particles. Because of the large coincident surface areas, the platelet-to-platelet contact area is higher than the contact area for carbon rods or particles. The addition of carbon particles and carbon rods changes the porosity of the structure.

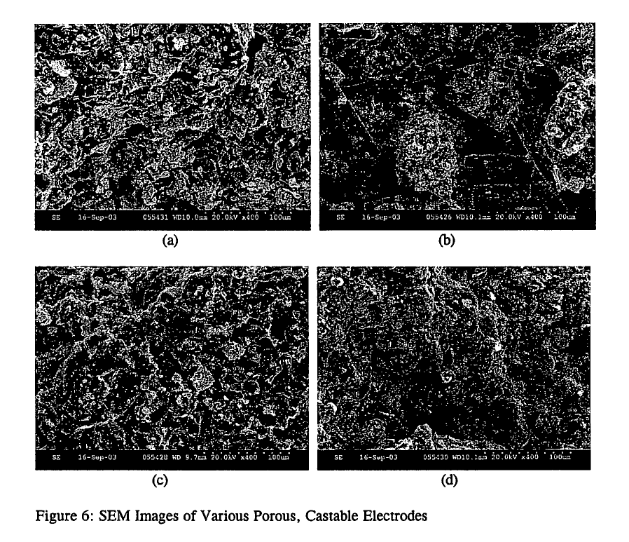

FIGS. 6(a)-(d) illustrates the structure of the porous layers. The compositions of the respective images are summarized in the following Table 1.

TABLE 1
Metal Foam Compositions and Resistivities

| | Epoxy | Ag_{flake} | C_{act} | C_{rod} | PTFE | Solvent | σ |
|---|---|---|---|---|---|---|---|
| Name | (g) | (g) | (g) | (g) | (g) | (g) | (Ω/cm) |
| A | 0.3 | 0.5 | 0.3 | 0 | 0 | 0.6 | 3 × 10⁵ |
| B | 0.3 | 0.5 | 0.3 | 0.1 | 0 | 0.5 | 5 × 10⁴ |
| C | 0.3 | 0.5 | 0.3 | 0 | 0 | 0 | 1.25 × 10⁵ |
| D | 0.2 | 0.3 | 0.2 | 0 | 0.2 | 0 | 1 × 10⁴ |

Two things are readily apparent from examining the SEM images in FIG. 6(a)-(d): all structures are highly porous, and the microstructure of each foam is very different. Sample (a), prepared as an ink with only silver and carbon particles has the highest conductivity, exhibits a flaky texture. This flaky texture likely maximizes the silver-silver contact generating the maximum conductivity. The carbon agglomerates break the silver scales sufficiently to form pores between 1 and 10 um in diameter. The carbon fiber system had the greatest pore sizes, but the lowest conductivity, likely because of the poor adhesion between the silver and carbon fibers. The carbon fibers break up the silver scales increasing the porosity, but do not provide short circuit paths as they do in the catalyst layer because poor adhesion to silver isolates them from the primary conductive path. Carbon fibers may be appropriate if other metal flakes are employed. The sample in (c) is the same as the sample in (a) except the sample was prepared as a paste instead of an ink by reducing the solvent content. The effect seems to be a greater agglomeration of carbon particles, disrupting the scales in the first instance. The final sample is similar to (a) and (c) except it replaces some binder with colloidal Teflon®. As in catalyst layers, Teflon® content seems to increase the pore size of the film. The decrease in conductivity could be a result of the lower silver loading more than the topology of the layer. However, it is notable that the highly conductive scale topology in (a) is muted in (d). This is likely the result of the difference in solvent concentration as similar structures are seen in (c).

As will be appreciated by a person skilled in the art, a microcell may be prepared comprising the porous metal foam as an additional layer over the catalyst layer. The result should be significantly improved performance, as the resistance decreases and the path through the catalyst is also decreased, as most of the electrons will be removed through the thickness of the stripe rather than across its width. This new cell materials and construction will remove a significant limiting factor on the performance of compressionless cell architectures.

Passive Mixing Flow Fields

In polymer electrolyte membrane (PEM) fuel cells and micro fuel cells, the fluid flow in small/micro channels is laminar, and reactants contact the catalyst layer only through diffusion. Because the diffusion time is short (for hydrogen, the speed can reach 12 m/s in the channel) or diffusivity is low (for liquid fuel), reactants in the channel cannot mix efficiently. Removal of the reaction products from the membrane is also problematic. Carbon dioxide or water build-up can also reduce catalyst layer efficiency and block small/micro channels.

In the prior art design of flow fields for fuel cells, different kinds of obstacles are placed in the channels to disturb the laminar flow along the channels leading to turbulent or transverse flow which improves the contact probability between the reactants and catalyst layer. However, turbulent or transverse flow in the channel caused by these obstacles causes additive pressure loss.

Such obstacles with different structures are designed to improve the reaction efficiency by making more turbulent or transverse flow in the channel, not by controlling the transverse flow behaviour. More obstacles in a flow field cause more pressure loss because these obstacles baffle the flow along the channel. Some complicated obstacles, such as helical obstacles, are difficult to manufacture. In fuel cells, high internal pressure and speed of flow requires high strength obstacles, which also increase difficulty in fabricating obstacles. For example, Dong et al., US published application no. 2002/0119360, published Aug. 29, 2002, typifies the prior art.

According to the present invention, a plurality of periodic groove structures, sometimes referred to herein as secondary channels, are fabricated in fuel cell flow fields to provide a transverse pressure gradient in the channels and a transverse component of axial flow. Thus, uniaxial laminar flow is turned into controlled transverse rotating laminar flow in the channel(s) of the flow field, improving mass transport of reactants to the catalyst layer in the fuel cell, while facilitating removal of the reaction products. The principle, structure and design of grooves are outlined below.

Fuel cells convert reactants, namely fuel and oxidant, to generate electric power and reaction products. Fuel cells generally employ an electrolyte between two electrodes, namely a cathode and an anode. Preferred fuel cell types include solid polymer electrolyte fuel cells that comprise a solid polymer electrolyte membrane (PEM). A catalyst typically induces the desired electrochemical reactions at the electrodes. Fuel and oxidant is supplied to the anode and cathode through the flow fields at anode and cathode sides. Conventional flow fields include one or more straight channels. In fuel cells, the concentration of reactants near the catalyst layer decreases as reactants are consumed. Simultaneously, the concentration of reaction products increases. High concentrations of reactants near the bottom of the flow field slowly rise to the surface of catalyst layers, reducing the performance of fuel cells operating in high current regimes. Similarly, the concentration of reaction products near the interface of the catalyst layer and the membrane can quickly reach the saturation point. The formation of a layer in which reactants are depleted and reaction products are rich lowers the reaction rate and limits the electric power that can be generated by the fuel cell.

Turbulent mixing is extremely difficult to achieve and maintain in small/micro channels. To increase the concentration of reactants near the catalyst layer, adding transverse laminar components to the main laminar flow along the channels is recommended. Transverse laminar flows in small/micro channels can transfer reactants with higher concentration to the catalyst layer by two ways:
(i) Stretch and fold volumes of fluid over the cross section to accelerate the diffusion process by increasing contact area.
(ii) Propel the fluid with high-concentration reactants toward the catalyst layer and remove the reaction products from the catalyst layer. Transverse flow in small/micro channels can improve the electrochemical reaction rate and thus the fuel cell performance.

In general, pressure flow is laminar and uniaxial in simple small/micro channels because of the low Reynolds number. In the present invention, to generate transverse laminar flow in small/micro channels using a steady axial pressure, a plurality of secondary channels or grooves are put on at least one of the surfaces of channels at an oblique angle with respect to the longitudinal axis of the primary channel. Fluid flows along the grooves and causes a transverse pressure gradient at this interface between the secondary channels and the primary channel. As a result of this anisotropic pressure, transverse components of flow originate at this interface and cause the rotation of fluids in the channels. By arranging the secondary channels or grooves regularly along the primary channel(s), this transverse pressure gradient can vary periodically and thus the transverse laminar flow can rotate within the channel(s).

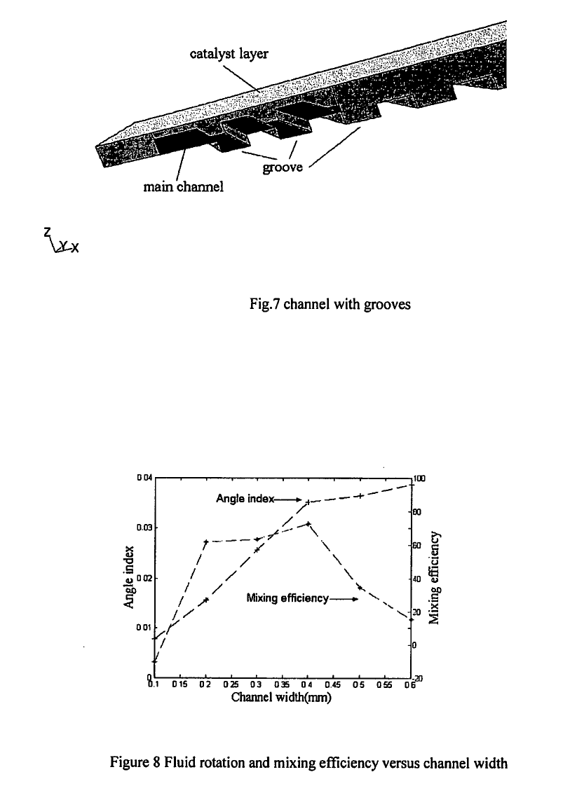

The transverse flow can be controlled by providing a plurality of periodic transverse secondary channels or grooves of which different dimensions and structures are possible (as shown in FIG. 7). It will be appreciated that the secondary channels or grooves are arranged substantially in parallel and many spacings are possible, although in some embodiments this may not be the case. The velocity vector of flow in the channel(s) with grooves can be divided into two components that are due respectively to the pressure gradient along the channel and in the cross section of the channel. The transverse pressure gradient is dictated by flow velocity, fluid properties, the channel profile and the groove or secondary channel structure.

Computational fluid dynamics (CFD) computer simulations were conducted to determine the effect of the structural parameters on the transverse flow. The ratio of the transverse component to the axial component of the velocity, called the angle index, can be used as the index of the flow rotation state. FIG. 8 shows the curve of the angle index to the main channel width. (In this case, the grooves are 200 μm deep, and the angle between the grooves and the main channel axis is 45°.) The angle index increases with channel width. However, the angle index increases slowly above a channel width of 400 μm. It is also shown that mixing efficiency is not consistent with the transverse flow state.

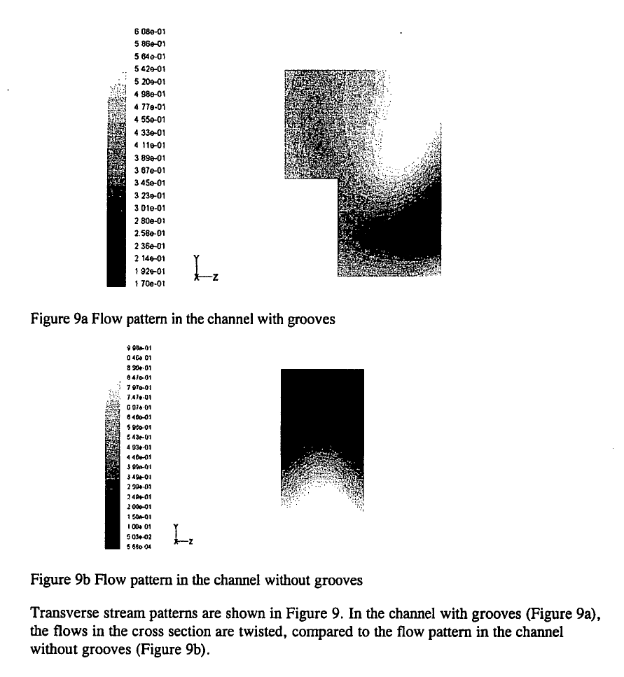

Transverse flow patterns are shown if FIGS. 9(a) and 9(b). In the channel with grooves (FIG. 9(a)), the flows in the cross-section are twisted or rotating compared to the flow pattern in the channel with grooves (FIG. 9(b)).

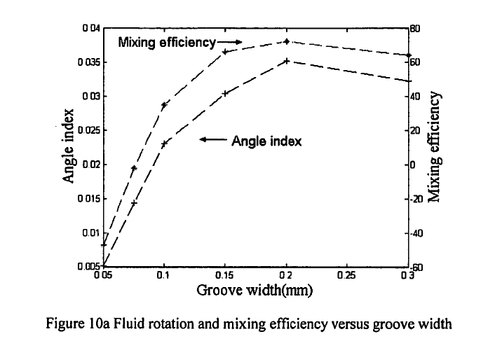

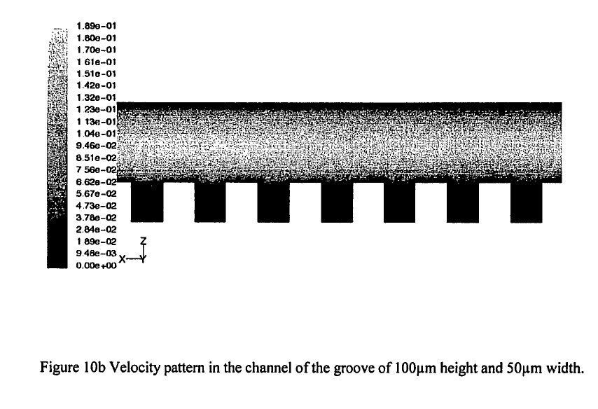

FIG. 10(a) and 10(b) illustrate the relationship between transverse flow (angle index) and grooves width. In this case, the main or primary channel is 400 μm wide, 200 μm high and 10 mm long. The angle between the groove or secondary channel and the primary channel is 45°. The secondary channel or groove is 100 μm deep.

FIG. 10a graphically illustrates the relationship between the angle index and the groove width. The angle index goes down with deeper grooves or secondary channels. The higher aspect ratio creates stagnant zones in the grooves (secondary channels), as shown in FIG. 10(b) and cuts down the effect of grooves (secondary channels) on the transverse pressure gradient. It is also shown that the curve of the angle index to the groove width is similar to that of mixing index to the groove width.

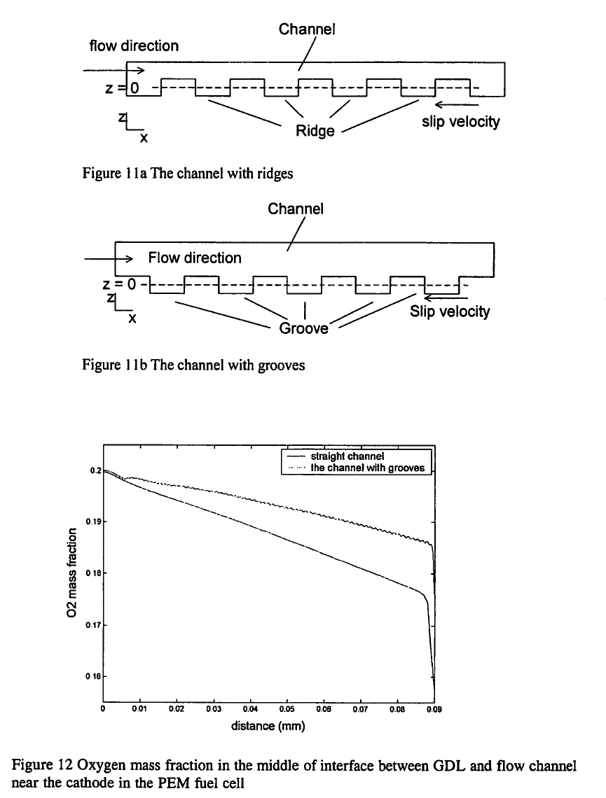

FIGS. 11(a) and 11(b) illustrate a comparison between a channel having obstacles e.g. ridges, according to the prior art (FIG. 11(a)) and a channel according to the invention (FIG. 11(b) having a plurality of transverse grooves or secondary channels in a surface of the primary channel.

It is emphasized that the pressure drop in the primary channel with grooves (secondary channels) is significantly less than that in the primary channel with obstacles. The concept of the effective boundary condition on a rough surface can be used to give a qualitative explanation on lower pressure drops in the primary channel with grooves (secondary channels). In order to simulate the steady pressure-driven viscous fluid flows over the rough surface, the resistance of a rough surface in the channel can be equal to the slip boundary condition at the plane of z=0 in which the effective slip velocity is opposite to that in the main channel, as shown in FIG. 11(a) and (b). In the channel with grooves or secondary channels, the effective height of the primary channel is the sum of channel width and half the depth of the groove, as shown in FIG. 11(b). In other words, the effective height of the primary channel is slightly bigger than the actual value of the primary channel and helps to reduce the pressure loss that is caused by the negative slip velocity. In this example, the simulation result of pressure loss in a simple channel (without grooves or obstacles) is 4.2 Pa, which is a little higher than that in the channel with grooves or secondary channels: 3.58 Pa, but the pressure loss in the channel with ridges is much larger: 14 Pa. (The channel is 10 mm long, 400 μm wide, 200 μm high. The ridge is 200 μm wide, 100 μm high. The groove is 200 μm wide, 100 μm deep.). Compared with the pressure loss in the 30 mm-long straight, simple channel, pressure loss in the channel with 40 grooves or secondary channels decreases by 12%, but increases by 84% in the channel with 40 pieces of obstacles.

Fluid streams rotate in the whole flow field with grooves or secondary channels and change the concentration distribution of reactants and reaction products in the whole channel(s). Simulation has been done to analyse the oxygen concentration in a PEM fuel cell. Simulation conditions are listed as follows:
channel dimension:
   width=0.9 mm
   height=0.9 mm
   length=90 mm
groove dimension:
   width=0.45 mm
   depth=0.225 mm
distance between grooves=0.45 mm
angle with respect to the channel=45°
gas diffusion layer thickness=180 μm
at the anode channel inlet, mass flow rate is 4×10-7 Kg/s, and consists of 20% hydrogen and 80% water vapour by mass fraction. At the cathode channel inlet, mass flow rate is 4.5×10-6 kg/s and consist of 20% oxygen, 16% water vapour, and the remainder nitrogen.
Temperature=80° C.

FIG. 12 shows the oxygen concentration increases in accordance with the invention in the whole channel (in FIG. 12 the upper line shows a primary channels with grooves or secondary channels and the lower line shows a straight channel without grooves). In this example, the oxygen mass fraction was determined in the middle of the interface between a gas diffusion layer (GDL) and a flow channel near the cathode in a PEM fuel cell. As will be apparent to a person skilled in the art, rotating flow is also helpful to decrease the concentration of reaction gas products and to remove liquid water.

The grooves and channels thus constitute a two-layer flow field for fuel cell. As will be appreciated by a person skilled in the art, different kinds of microfabrication technology can be used to manufacture such a flow field, such as hot embossing, screen printing, molding, etc. The grooves are easily integrated into flow fields for fuel cells because the simple groove structure can be made by 2-D fabrication technology. Flexible groove structure designs can also simplify the requirement on fabrication precision. Currently the channels and grooves are manufactured at one step by molding with PDMS

In summary, the present invention includes a flow field with a plurality of periodic grooves or secondary channels for a solid polymer electrolyte fuel cell. The secondary channels turn conventional laminar flow in the primary channel into a controlled transverse-rotating laminar flow, improving reactant and reaction product distribution and the performance of the fuel cell. The character of laminar fluid stream is maintained in the whole flow field, and lower pressure loss than that in the conventional flow field is obtained.

It will be appreciated by those skilled in the art that grooves or secondary channels in the flow field are the structures that sink under the floor of the flow field, the sidewalls of the flow field, or both. Grooves can be integrally formed in the anode flow field, cathode flow field, or both at an oblique angle with respect to the longitudinal axis of the primary flow channel.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A hybrid catalyst layer deposited on a membrane substrate comprising:
(a) a plurality of catalyst particles; and
(b) a plurality of fibers blended with said catalyst particles.
wherein the concentration of said catalyst particles decreases with increasing distance from said membrane.

2. The catalyst layer as defined in claim 1, wherein said fibers are not in contact with said membrane and wherein the concentration of said fibers increases with increasing distance from said membrane.

3. The catalyst layer as defined in claim 2, wherein the concentration of said catalyst particles gradually decreases proportionately with distance from said membrane and the concentration of fibers gradually increases proportionately with distance from said membrane.

4. The catalyst layer as defined in claim 1, wherein said catalyst layer is electrically conductive.

5. The catalyst layer as defined in claim 4, wherein said catalyst particles comprise platinum on activated carbon.

6. The catalyst layer as defined in claim 5, wherein the loading of platinum on said activated carbon increases as the concentration of said catalyst particles in said layer decreases.

7. The catalyst layer as defined in claim 1, wherein said fibers are graphite fibers.

8. The catalyst layer as defined in claim 1, wherein said catalyst layer is uncompressed.

9. The catalyst layer as defined in claim 1, comprising a plurality of sub-layers, wherein the weight percentage of fibers in said sub-layers varies.

10. The catalyst layer as defined in claim 9, wherein said weight percentage of fibers increases with increasing distance from said membrane.

11. The catalyst layer as defined in claim 1, wherein said layer comprises a Nafion® ionomer.

12. An electrode subassembly for a micro fuel cell comprising a polymer electrolyte membrane and a hybrid catalyst layer as defined in claim 1 coated on said membrane.

13. An electrode for a micro fuel cell comprising an electrode subassembly as defined in claim 12 and a current collector contacting said hybrid catalyst layer.

14. A method of forming a hybrid catalyst layer comprising:
(a) providing a membrane substrate;
(b) depositing a primary sub-layer of catalyst particles on said membrane; and
(c) successively depositing a plurality of secondary sub-layers on said membrane overlying said primary sub-layer, wherein said each of said secondary layers comprises a blend of catalyst particles and fibers such that the concentration of fibers in said layer gradually increases with increasing distance from said membrane.

15. The method as defined in claim 14, wherein each of said sub-layers is deposited as an ink.

16. The method as defined in claim 14, wherein said ink comprises a conductive ionomer.

17. A porous, conductive gas diffusion layer for a fuel cell electrode comprising:
(a) conductive metal flakes;
(b) carbon particles; and
(c) binder holding said flakes and particles together to form a porous foam microstructure.

18. The gas diffusion layer as defined in claim 17, wherein said conductive metal flakes are formed of silver or gold.

19. The gas diffusion layer as defined in claim 17, wherein said layer is castable.

20. The gas diffusion layer as defined in claim 17, wherein said carbon particles are selected from the group consisting of carbon rods, carbon fibers and carbon powder.

21. The gas diffusion layer as defined in claim 17, wherein said binder is epoxy.

22. The gas diffusion layer as defined in claim 17, further comprising polytetrafluoroethylene.

23. The gas diffusion layer as defined in claim 17, wherein pores within said microstructure are between 1 and 10 μm in diameter.

24. An electrode subassembly comprising a hybrid catalyst layer as defined in claim 1 and a conductive gas diffusion layer as defined in claim 17 deposited thereon.

25. The electrode subassembly as defined in claim 24, wherein said subassembly is uncompressed.

26. A flow field for flowing fluid to or from the catalyst layer of a fuel cell comprising:
(a) at least one primary channel having a longitudinal axis;
(b) a plurality of secondary channels extending transversely from said primary channel at an angle relative to said longitudinal axis,
wherein said fluid flows within said primary and secondary channels at least part of the time in a non-uniaxial flow path to passively increase the probability of contact between said fluid and said catalyst layer.

27. The flow field as defined in claim 26, wherein said non-uniaxial flow path is a rotating flow path.

28. The flow field as defined in claim 27, wherein a pressure gradient develops at interfaces between said primary channel and said secondary channels to cause said rotating flow.

29. The flow field as defined in claim 26, wherein said flow of said fluid through said primary and secondary channels is laminar.

30. The flow field as defined in claim 26, wherein said angle is an oblique angle.

31. The flow field as defined in claim 26, wherein said fluid delivers reactants to said catalyst layer and removes reaction products from said catalyst layer.

32. The flow field as defined in claim 27, wherein rotating flow increases the mixing efficiency of said fluid and said catalyst layer.

33. The flow field as defined in claim 26, wherein said secondary channels are formed in a bottom or side surface of said primary channel.

34. The flow field as defined in claim 26, wherein said secondary channels are arranged at regular intervals along said longitudinal axis.

35. An electrode subassembly comprising a catalyst layer as defmed in claim I and a flow field as defined in claim 26.

36. The electrode subassembly as defined in claim 35, wherein said catalyst layer is applied to a membrane substrate.

37. The electrode subassembly as defined in claim 36, further comprising a gas diffusion layer as defined in claim 17 in electrical contact with said catalyst layer.

38. The electrode subassembly as defined in claim 37, wherein said subassembly is uncompressed.

39. An electrically conductive hydrid catalyst layer deposited on a membrane substrate comprising:
(a) a plurality of catalyst particles; and
(b) a plurality of fibers blended with said catalyst particles.
wherein the concentration of said catalyst particles decreases with increasing distance from said membrane.

40. The catalyst layer as defined in claim 39, wherein the concentration of catalyst particles is maximized in a region of said layer closest to said membrane.
